(19) United States
(12) Patent Application Publication
(10) Pub. No.: US 2026/0208608 A1
(43) Pub. Date: Jul. 23, 2026

(54) STATIONARY INDUCTION CHARGING DEVICE, AND INDUCTIVE VEHICLE CHARGING SYSTEM COMPRISING SAME

(71) Applicant: MAHLE International GmbH, Stuttgart (DE)

(72) Inventors: Stefan Hirsch, Stuttgart (DE); Christopher Laemmle, Stuttgart (DE); Holger Schroth, Maulbronn (DE)

(21) Appl. No.: 19/136,848

(22) PCT Filed: Dec. 1, 2023
(86) PCT No.: PCT/EP2023/084011

§ 371 Date: Jun. 6, 2025

(30) Foreign Application Priority Data
Dec. 9, 2022 (DE) 10 2022 213 357.9

(51) Int. Cl. B60L 53/302; B60L 53/122

(52) U.S. Cl. CPC B60L 53/302; B60L 53/122

(57) ABSTRACT

A stationary induction charging device for charging a battery electric vehicle includes a housing with a heat-dissipating base plate and a cover. An inductive charging device inside the housing is in thermal contact with the base plate and enables inductive energy transfer with a vehicle. A central air circulation device directs airflow along a path through the housing to cool the base plate and regulate device temperature.

### CROSS-REFERENCE TO RELATED APPLICATIONS

This application claims priority to International Patent Application No. PCT/EP2023/084011, filed on Dec. 1, 2023, and German Patent Application No. 102022213357.9, filed on Dec. 9, 2022, the contents of both of which are hereby incorporated by reference in their entirety.

### TECHNICAL FIELD

The disclosure relates to a stationary induction charging device. The disclosure relates in particular to an inductive vehicle charging system with a stationary induction charging device of this kind.

### BACKGROUND

Inductive vehicle charging systems for charging the battery of a battery electric vehicle use stationary induction charging devices that can be arranged on a flat surface-such as the floor of a garage or a parking lot-and are also referred to as GA (Ground assembly) in practice. They are designed for electromagnetic interaction with an induction charging device assigned to the battery electric vehicle, which is designated as VA (Vehicle assembly), so that electrical energy can be transferred from the vehicle charging system to the battery electric vehicle and vice versa. During operation, heat loss occurs in the stationary induction charging device, which is mainly conducted into a base plate of the stationary induction charging device and from there is dissipated convectively to the ambient air on the one hand and by heat conduction to a flat surface on the other. This allows for relatively effective cooling and avoids the risk of overheating, especially at high ambient temperatures. However, at relatively high transmission powers of the stationary induction charging device and/or at high ambient temperatures, the cooling is not sufficient. In particular, unwanted heat hotspots can occur at critical components of the stationary induction charging device.

### SUMMARY

The object of the disclosure is therefore to provide an improved or at least a different embodiment of a stationary induction charging device and/or an improved inductive vehicle charging system for charging a battery of a battery electric vehicle with electric energy.

In the present disclosure, this task is solved in particular by the subject matter of the independent claims. Advantageous embodiments are the subject of the dependent claims and the description.

The basic idea of the disclosure is to transport waste heat, which is generated during the operation of the stationary induction charging device, in particular at an inductive charging device set up for electromagnetic interaction with an on-board induction charging device, by convection to a base plate of the stationary induction charging device that is set up to dissipate heat to an environment.

For this purpose, a stationary induction charging device that can be permanently installed on a flat surface is proposed for an inductive vehicle charging system designed to charge a battery of a battery electric vehicle with electrical energy. It indicates at least the following:
a housing which has a base plate and a cover arranged thereon, wherein the base plate has or can form a collar which projects beyond the cover and runs around it at least in sections, and is designed to dissipate heat to an environment of the stationary induction charging device, in particular to the flat surface and via the collar to ambient air,
an inductive charging device, which is arranged in an interior of the housing, which is delimited by the base plate and the cover, in thermal contact with the base plate and is set up for electromagnetic interaction with an induction charging device associated with the battery electric vehicle, so that electrical energy can be inductively transferred from the stationary induction charging device to the battery electric vehicle and vice versa,
an air circulation device, which is advantageously arranged in a complete and centralized fashion, i.e. in particular in the center of the base plate, in the interior, for controlling the temperature of the stationary induction charging device, which conveys an air stream from air along a circulation path that extends through the interior and in the interior at least in sections along the base plate, so that the air stream washes the base plate at least in sections.

The air stream can be used to transport waste heat generated during the operation of the inductive vehicle charging system, for example in the inductive charging device, to the base plate of the stationary induction charging device and along it. In this way, at least some of the waste heat carried in the air stream can be transferred to the base plate and, by means of the base plate, dissipated into the environment of the stationary induction charging device, in particular to the flat surface on which the stationary induction charging device can be placed, and, if the base plate forms a collar, to the ambient air surrounding the stationary induction charging device. This has the advantage that the stationary induction charging device can be cooled better overall, which means that the stationary induction charging device can be operated without reducing the transmission power, even at relatively high ambient temperatures. In addition, a certain homogenization of the heat distribution can be achieved by means of the circulation of the air in the interior, which successfully prevents local heat hotspots at critical components of the stationary induction charging device, such as the inductive charging device.

The said cover may be made of a plastic material. The base plate in question and, for practical purposes, its collar can be made of an aluminum material.

Furthermore, it should be mentioned that the terms “heat loss” and “waste heat” are used synonymously in this document.

It is expediently envisaged that the inductive charging device has an energy coil that provides an electromagnetic field for electromagnetic interaction with the induction charging device associated with the battery electric vehicle, wherein the inductive charging device also has an arrangement associated with the energy coil and comprising magnetic field conductors for guiding the electromagnetic field provided by the energy coil. The circulation path extends at least in sections along the magnetic field conductors, so that the air stream flows around or over the magnetic field conductors at least in sections. In particular, the air stream can extend along central magnetic field conductors arranged in a central area of the stationary induction charging device, so that these central magnetic field conductors are flushed or washed around, at least in sections. This allows at least some of the heat generated at the magnetic field conductors to be transported from the magnetic field conductors to the base plate. The central magnetic field conductors are appropriately framed by outer magnetic field conductors. This allows the waste heat generated by the air stream at the magnetic field conductors, in particular the central magnetic field conductors, during the operation of the stationary induction charging device to be removed from the same. This ensures that all magnetic field conductors in the arrangement, in particular the central magnetic field conductors, are cooled relatively well and homogeneously. Furthermore, the magnetic field conductors, in particular the central magnetic field conductors, have a relatively even average temperature. The magnetic field conductors are made of ferrite so that they are suitable for conducting the electromagnetic field provided by the energy coil.

Furthermore, it may be expedient to provide that the stationary induction charging device has a supporting structure arranged in the interior, which is designed to support an arrangement of magnetic field conductors for guiding an electromagnetic field provided by an energy coil of the inductive charging device on the base plate, to support the cover on the base plate and to dissipate heat from the magnetic field conductors to the base plate. The circulation path extends at least in sections along the supporting structure, so that the air stream flows around or through the supporting structure at least in sections. On the basis of the air stream, at least some of the waste heat generated at the supporting structure, which in particular originates from the magnetic field conductors, can be absorbed by the air flowing around it, with the remaining heat in the supporting structure being conducted into the base plate by means of the supporting structure itself through heat conduction. This results in an overall improvement in the cooling of the supporting structure and the magnetic field conductor.

It may be expedient to provide that the supporting structure has columnar support bodies, by means of which the cover and the magnetic field conductors of the arrangement are supported on the base plate. The circulation path is routed along the support bodies in such a way that the air stream flushes and/or washes around the support bodies, at least in sections.

The specialist can see that, with the stationary induction charging device presented and a loss of heat in the base plate that is distributed as evenly as possible over all magnetic field conductors, a temperature gradient arises that has a relatively high temperature in the center of the base plate and a significantly lower temperature at the edge of the base plate-and in particular at the protruding collar of the base plate. Consequently, the heat sink arranged at the foot is worse for the central supporting structures compared to the supporting structures arranged close to the edge.

In this regard, the support bodies can be usefully divided into a first group of support bodies, which are assigned to central magnetic field conductors of the arrangement, and a second group of support bodies, which are assigned to outer magnetic field conductors that frame the central magnetic field conductors. The central magnetic field conductors of the arrangement are appropriately those magnetic field conductors of the arrangement which are arranged in a central area of the stationary induction charging device and/or which are framed by further, so-called outer magnetic field conductors. In order to be able to remove heat loss from the central magnetic field conductors of the arrangement in a targeted manner, it is expedient to provide that the said circulation path extends through the central magnetic field conductors or at least passes them. This allows the conveyed air stream to flush and/or envelop the support bodies assigned to the central magnetic field conductors at least in sections, thereby dissipating heat from these support bodies. The advantage of this is that heat loss that occurs and accumulates in the area of the central magnetic field conductors during operation of the stationary induction charging device can be efficiently dissipated into the base plate, thus compensating for the disadvantageous effects of a higher heat sink temperature at the base of the support body. This effectively achieves a homogeneous or at least more homogeneous temperature distribution in the magnetic field conductors.

In this context, it may be envisaged that at least one support body has a through-opening passing through the support body and heat exchanger fins inserted into the support body, arranged on the support body and oriented parallel with respect to the direction of flow of the air stream. The circulation path extends along the heat exchanger fins through the through-opening in such a way that the air stream flushes the at least one support body and the heat exchanger fins. Furthermore, it may be provided that at least one support body of these support bodies has a peripheral wall, the circulation path being guided completely around the peripheral wall in two partial paths, so that the air stream flows around the peripheral wall. Alternatively, it is conceivable that at least one support body of these support bodies has a peripheral wall with horizontal heat exchanger fins oriented parallel to the direction of flow of the air stream, the circulation path being guided around the peripheral wall in two partial paths, so that the air stream flows around the peripheral wall and the horizontal heat exchanger fins. Furthermore, it may be provided that the at least one support body has a through-opening passing through the support body and a heat exchanger fin that is inserted into the opening, arranged on the support body and oriented transversely with respect to the direction of flow of the air stream. The circulation path extends along the heat exchanger fin through the through-opening in such a way that the air stream flushes the at least one support body and flushes the heat exchanger fin. The support bodies are preferably molded from a heat-conducting material-for example, from metal, preferably from an aluminum material. The column-shaped support bodies can also have a cylindrical base body, the cover surfaces of which are supported on the cover and/or on the magnetic field conductors of the arrangement and on the base plate, and the outer surface of which forms the said peripheral wall. The cylindrical base body can have round, oval or rectangular cover surfaces, so that it forms a circular cylinder, an elliptical cylinder or a polygonal cylinder. Generally speaking, the base body is a prismatic base body with a cover surface in any shape.

Furthermore, it is useful if the base plate of the stationary induction charging device has a collar that extends above the cover, at least in some sections. This is appropriately designed to release heat into the environment around the stationary induction charging device.

In this context, it is also useful if heat-transferring cooling fins are arranged on the said collar, facing away from the flat surface, which are suitable for releasing heat into the environment.

Furthermore, it may be expedient to provide that the air circulation device has at least one air duct for conducting air and that at least one air gap for conducting air is defined in the interior. The circulation path extends through the at least one air duct and the at least one air gap in such a way that the air stream flushes the at least one air duct and the at least one air gap. It is practical that the at least one air duct is made of a plastic material. This makes it relatively lightweight, inexpensive to manufacture and an electromagnetic interaction between the stationary induction charging device and the on-board induction charging device remains unaffected.

It may be expedient to provide that the at least one air duct is realized from the base plate or magnetic field conductors for guiding an electromagnetic field, provided by an energy coil of the inductive charging device, of an arrangement and a U-shaped strip body, which has a bottom and side walls connected to one another above the latter and is arranged on the base plate or the magnetic field conductors by means of its side walls, forming an almost completely fluid-tight or fluid-tight air duct. The air duct, of which there is at least one, is therefore designed in several parts, wherein it only forms an air duct for conducting air when it is assembled, for example when its strip body with its side walls is arranged as fluid-tight as possible or fluid-tight on the base plate or the magnetic field conductors. Since the strip body is open on one side, the air duct(s) can be provided relatively easily and at a low cost. Alternatively, it may also be envisaged that the at least one air duct is realized from a tubular body, in particular from a rectangular tube. A corresponding pipe body is relatively easy to install in the interior of the stationary induction charging device. In addition, pipe bodies can be procured relatively inexpensively and in large quantities. Furthermore, it is conceivable that at least one air duct is realized from an elastic hose body. Such hose bodies can be flexibly mounted, i.e. laid, and, as with the tubular body, can be purchased in the interior of the stationary induction charging device in a comparatively cost-effective manner and in large quantities.

Furthermore, it may be expedient to provide that the at least one air gap between the at least one air duct and magnetic field conductors for guiding an electromagnetic field provided by an energy coil of the inductive charging device is limited to one arrangement and the at least one air duct is supported or formed on the base plate. Alternatively, it may also be envisaged that the at least one air gap between the at least one air duct and the base plate is limited and the at least one air duct is supported on or formed by magnetic field conductors for guiding an electromagnetic field of an arrangement provided by an energy coil of the inductive charging device. Furthermore, it is conceivable that the at least one air gap is at least in sections defined between the at least one air duct and magnetic field conductors for guiding an electromagnetic field of an arrangement, which field is provided by an energy coil of the inductive charging device, and at least in sections between the at least one air duct and the base plate, and the at least one air duct is supported or formed at least in sections on the base plate and at least in sections on the magnetic field conductors. This indicates preferred embodiments that differ in the arrangement of the air duct and the air gap. In particular, they can achieve additional cooling in the area of the magnetic field conductors and at the same time enable simple and cost-effective production of the stationary induction charging device.

It is expedient for the air circulation device to have at least one fan, or preferably two fans, to move air along the circulation path. In this case, the at least one fan in the interior can be arranged on a central surface of the base plate. In this case, it is useful if at least one fan has a relatively low design. Furthermore, it can be advantageous for the electromagnetic interaction between the stationary induction charging device and the on-board induction charging device if the at least one fan has no or at least relatively few electrically conductive materials.

It is expedient that the air circulation device has at least one heat exchanger duct for transferring heat from the air stream to the base plate, which is arranged on a central surface of the base plate, framing an edge surface of the base plate in the manner of a frame. The circulation path extends through the at least one heat exchanger duct in such a way that the air stream flushes the at least one heat exchanger duct. At least one heat exchanger duct is made of an electrically non-conductive material, such as plastic. With regard to electromagnetic interactions, it is also conceivable that at least one heat transfer duct is made of a material with particularly high electrical and thermal conductivity, such as metal, preferably an aluminum material.

Furthermore, it is expediently provided that the at least one heat exchanger duct has at least one of the following features:
It is arranged in a corner area of the edge surface.
   This allows heat to be transported particularly into the corners of the interior and introduced there into the base plate, wherein a removal of heat from the stationary induction charging device by means of the corner areas of the base plate is particularly effective, since the ratio between a collar arranged in a protruding manner and the inner area assigned to it is particularly large there and thus the cooling is particularly effective.
It is made from a tubular body, in particular from a rectangular tube.
   This allows the heat exchanger duct to guide the air stream. At the same time, the relatively warm air stream flowing through the heat exchanger duct is thermally insulated from the interior, thus protecting the components of the stationary induction charging device arranged in the interior.
It has heat exchanger fins to transfer heat from the air stream to the base plate and/or to guide the air stream.
   The heat exchanger fins are designed to effectively transfer heat from the air stream to the heat exchanger duct and then to the base plate.
It has air guide elements to direct the air stream and/or transfer heat from the air stream to the base plate.
   This allows the airflow to be directed as required within the heat exchanger duct.
It forms a T-shaped heat exchanger duct, which is used to separate the circulation path into two partial paths. Furthermore, it may be envisaged that at the end of each air stream path through the heat exchanger duct, the heat exchanger duct is designed to be open, so that the air can escape with practically no further flow resistance into the interior outside the aforementioned air flow ducts, in order to be fed from there to the at least one fan.

This provides features for at least one heat exchanger duct that can be used to improve the transfer of heat from the air stream to the base plate.

According to a further basic principle of the disclosure, an inductive vehicle charging system is provided that is designed to charge a battery of a battery electric vehicle with electrical energy and is equipped with a stationary induction charging device that is or can be arranged in a fixed position on a flat surface, as described above. This specifies an advantageous inductive vehicle charging system for charging a battery of a battery electric vehicle. Due to the improved cooling capability of the stationary induction charging device, charging can be realized without reducing the transmission power, even at relatively high ambient temperatures. This reduces the charging time required to charge the battery of the battery electric vehicle, which increases customer convenience when charging the battery electric vehicle.

To summarize, it remains to be said: The present disclosure relates in particular to a stationary induction charging device for an inductive vehicle charging system designed to charge a battery of a battery electric vehicle with electrical energy. It has a housing that has a base plate and a cover arranged on the latter, the base plate being designed to dissipate heat, an inductive charging device which is arranged in an interior bounded by the base plate and the cover and is set up for electromagnetic interaction with an induction charging device on a vehicle, and an air circulation device arranged in the interior for controlling the temperature of the stationary induction charging device, which conveys an air stream from air along a circulation path through the interior and at least in sections along the base plate, so that the base plate is washed, at least in sections. The disclosure relates in particular to an inductive vehicle charging system with a stationary induction charging device of this kind, arranged on a flat surface.

Further important features and advantages of the disclosure are apparent from the dependent claims, from the drawings, and from the associated description of the figures with reference to the drawings.

It is understood that the above-mentioned features and those yet to be explained below can be used not only in the combination indicated in each case, but also in other combinations or on their own, without deviating from the scope of the present disclosure.

Preferred embodiments of the disclosure are shown in the drawings and are explained in more detail in the following description, wherein identical reference signs refer to identical or similar or functionally identical components.

### BRIEF DESCRIPTION OF THE DRAWINGS

They show, schematically in each case:

FIGS. 1 and 2 each show a stationary induction charging device according to one or more examples of the disclosure in a plan view, with the cover of one of them almost completely removed to make an air circulation device easier to see.

FIGS. 3 through 5 each show a preferred embodiment of a stationary induction charging device according to the one or more examples of the disclosure in a sectional view,

FIGS. 6 and 7 each show a preferred air duct of an air circulation device of a preferred embodiment of the stationary induction charging device according to the one or more examples of the disclosure in a sectional view, and

FIGS. 8a) through 11b) each show a support body of a supporting structure of a preferred embodiment of the stationary induction charging device according to the one or more examples of the disclosure in a sectional and plan view.

### DETAILED DESCRIPTION

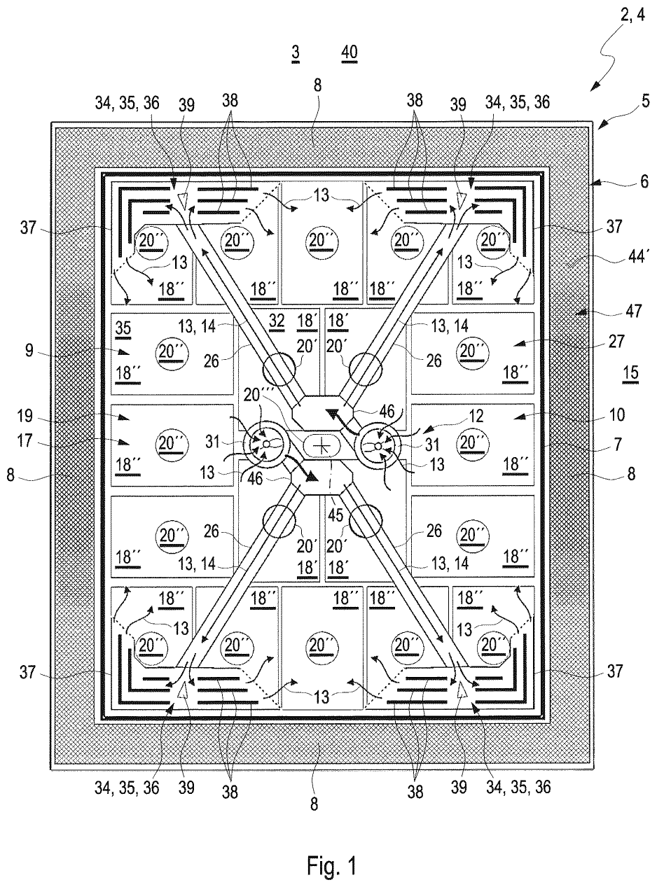

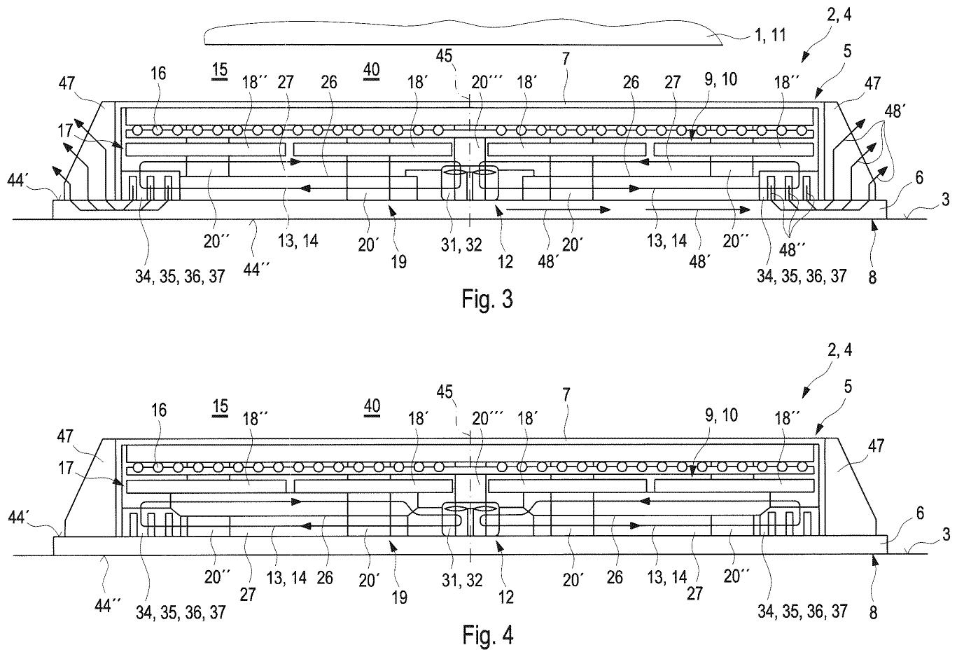

FIGS. 1 through 5 each show a preferred embodiment of a stationary induction charging device, designated as a whole by the reference number 4, which is associated with or forms an inductive vehicle charging system 2 that is designed to charge an unillustrated battery of a battery electric vehicle 1 that is only indicated in FIG. 3.

The stationary induction charging device 4 according to FIG. 1 has a housing 5 that is composed of a flat base plate 6 made of a heat-conductive material, in particular a metal, preferably an aluminum material, and a cover 7 made, for example, of plastic. The cuboid base plate 6 has two large-area, opposing, square base surfaces 44′, 44″, with the base plate 6 being placed with the one base surface 44″ on a flat surface 3 and being connected to it, for example. The said cover 7 is arranged on the other base surface 44′, facing away from the flat surface 3, of the base plate 6 in such a way that it makes contact and is connected, for example, to the base plate 6 by means of fastening screws or the like, which are not illustrated. In this way, the base plate 6 and the cover 7 delimit an interior 10, which is separated from the environment 15, i.e. the flat surface 3 and/or ambient air 40, of the stationary induction charging device 4, for example, can be designed to be fluid-tight in order to protect components of the stationary induction charging device 4 arranged in the interior 10 from harmful environmental influences. The base plate 6 extends horizontally beyond the cover 7, forming a collar 8 that completely encircles the cover 7. The base plate 6 (and the collar 8) is designed, in particular due to its metallic material, to dissipate heat loss occurring in the stationary induction charging device 4 during operation of the stationary induction charging device 4, i.e. when the battery of the battery electric vehicle 1, not illustrated, is charged or discharged, by heat conduction to the environment 15 of the stationary induction charging device 4, in particular to the flat surface 3 and/or the ambient air 40. Furthermore, in order to improve the heat conductivity of the base plate 6, it is conceivable that cooling fins 47 are arranged on a base surface 44′ on that side of the collar 8 that points away from the flat surface 3, by means of which ribs the convective heat dissipation between the base plate 6 or the collar 8 and the ambient air 40 is improved.

The stationary induction charging device 4 according to FIG. 1 also has an inductive charging device 9 which, by means of electromagnetic interaction with an induction charging device 11 associated with the battery electric vehicle 1, see FIG. 3, transfers electrical energy from the stationary induction charging device 4 to the battery of the battery electric vehicle 1 and vice versa. The inductive charging device 9 is arranged completely in the interior 10 and in thermal contact with the base plate 6, so that it is protected from environmental influences and, when the stationary induction charging device 4 is in operation, heat loss occurring at the inductive charging device 9 can be conducted via heat conduction into the base plate 6 (and the collar 8) and dissipated to the environment 15. FIG. 3 illustrates the latter by a corresponding heat flow 48′ expressed by arrows. In order to be able to realize the said electromagnetic interaction with the on-board induction charging device 11, the inductive charging device 9 has, among other things, a flat energy coil 16, which is only shown in FIGS. 3 through 5, which is located parallel to the base plate 6 and provides an electromagnetic field, not illustrated here, for the said electromagnetic interaction with the vehicle-side induction charging device 11. In order to be able to guide this electromagnetic field within certain limits, the inductive charging device 9 also has an arrangement 17 comprising of several tile-like, flat, ferritic magnetic field conductors 18′, 18″. These are laid out regularly next to one another like tiles in a common plane, arranged at a distance from and parallel to the base plate 6, and arranged on the energy coil 16 purely exemplarily on one side of the energy coil 16 facing the base plate 6, with central magnetic field conductors 18′ being framed by outer magnetic field conductors 18″.

The stationary induction charging device 4 also has a supporting structure 19 arranged in the interior 10 and comprising a plurality of column-shaped supporting bodies 20′, 20″, by means of which the cover 7 and the magnetic field conductors 18′, 18″ of the arrangement 17 on the base plate 6, and a central column 20″, which serves only to support the cover 7 with respect to the base plate 6. A first group of support bodies 20′ of said support bodies 20′, 20″, is assigned to the central magnetic field conductors 18′, while the remaining group of support bodies 20″ of the support bodies 20′, 20″ is assigned to the outer magnetic field conductors 18″. Particular attention must be paid to the support bodies 20′, 20″, as they must ensure that the stationary induction charging device 4 can be driven over by vehicles of all kinds without causing damage. The support bodies 20′, 20″ can therefore be made of metal, in particular an aluminum material, and, for example, each be formed by a circular cylinder, an elliptical cylinder or a polygonal cylinder, or have another prismatic basic structure. This design simultaneously allows a cooling function for the magnetic field conductors 18′, 18″ to be realized by heat conduction, in that the support bodies 20′, 20″ during operation of the stationary induction charging device 4 at magnetic field conductors 18′, 18″, the heat losses of the supporting bodies 20′, 20″ are conducted away from the magnetic field conductors 18′, 18″ into the base plate 6, as illustrated in FIG. 3 by the heat flow 48′. This allows relatively effective cooling to be realized and, in particular at high ambient temperatures, the risk of overheating of the stationary induction charging device 4 in the area of the magnetic field conductors 18′, 18″ can be avoided.

The applicant has found that when stationary induction charging device 4 is operated at a relatively high transmission power of the induction charging device 4 and/or at a relatively high ambient temperature, the heat loss occurring at magnetic field conductors 18′, 18″ accumulates, particularly at the central magnetic field conductors 18′, resulting in unwanted heat hotspots that need to be avoided.

To overcome this disadvantage, the stationary induction charging device 4 is provided with an air circulation device 12 that is arranged entirely in the interior 10 and conveys an air stream 13 along a circulation path 14 to control the temperature of the stationary induction charging device 4. The circulation path 14 extends through the interior 10 and, in particular, at least in sections along the base plate 6 in the interior 10, so that the air stream 13 can flush the base plate 6 at least in sections. With the air stream 13, waste heat that occurs during operation, for example in the inductive charging device 9, in particular at the magnetic field conductors 18′, 18″ and further in particular at the central magnetic field conductors 18′, can be transported to the base plate 6 and conducted along the same. At least some of the waste heat carried in the air stream 13 can be transferred to the base plate 6 and dissipated to the environment 15 by means of the same. This has the advantage that the stationary induction charging device 4, in particular the magnetic field conductors 18′, 18″, and in particular the central magnetic field conductors 18′ of the arrangement 17, whereby the operation of the stationary induction charging device 4 can be realized even at relatively high transmission power and relatively high ambient temperature without reducing the transmission power. Furthermore, a certain even distribution of the heat loss can be achieved by means of the circulation of the air in the interior 10, whereby a relatively even average temperature can be achieved and thus unwanted local heat hotspots on critical components can be prevented.

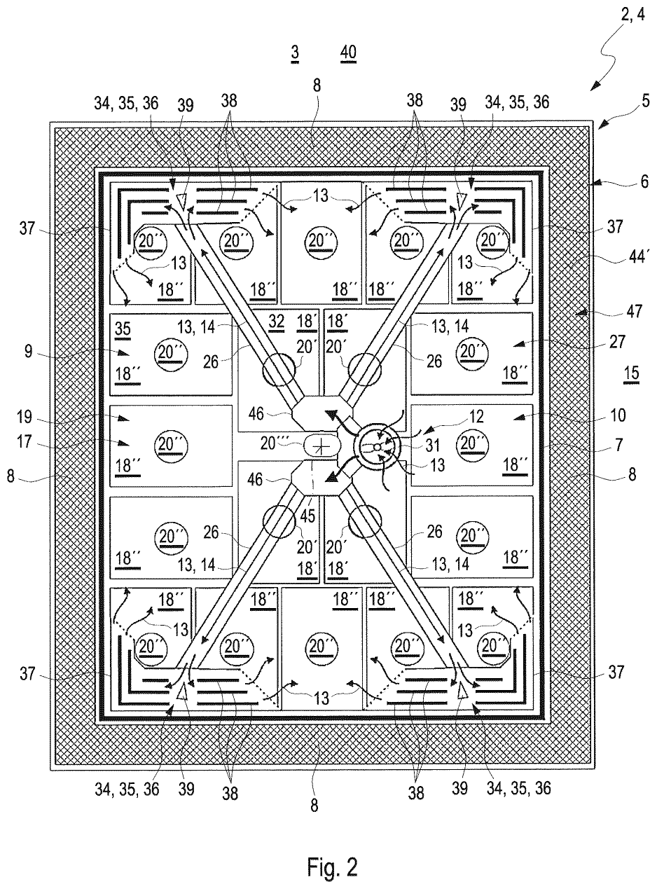

The air circulation device 12 as shown in FIG. 1 has two fans 31 arranged in the interior 10 on a central surface 32 of the base plate 6, which are each designed to convey air through the interior 10 along the circulation path 14 indicated by arrows in FIGS. 1 through 5. The air circulation device 12 has, so that the air in the interior 10 can be directed in a targeted manner, for example, four air ducts 26 arranged in the interior 10 for guiding air, as well as four heat exchanger ducts 34, each formed by a T-shaped pipe body 37, which are designed to transfer heat from the air stream 13 to the base plate 6 and to guide air. The heat exchanger ducts 34 have heat exchanger fins 38 for transferring heat from an air stream 13 to the base plate 6 and air guide elements 39 designed to guide the air stream 13. The air ducts 26 run from radially inward to radially outward, in particular radial, with respect to a centric center axis 45 that is perpendicular to the base plate 6, which is indicated in FIGS. 1 and 2 by a simple cross and in FIGS. 3 through 5 by a dashed-dotted line. The heat exchanger ducts 34 are arranged in an exemplary manner on an edge surface 35 of the base plate 6, which encloses the central surface 32 of the base plate 6 in the manner of a frame, in particular in corner areas 36 of the edge surface 35.

In the present case, the fans 31 are each fluidically connected to an air distributor 46 arranged on the central surface 32, which has a versatile, in particular 8-sided, prismatic basic shape. Two air ducts 26 are arranged fluidically on each air distributor 46 so that an air stream 13 of air can flow from the fans 31 via the air distributors 46 into the air ducts 26. The air ducts 26 are routed downstream of the air distributors 46 through and/or past the support bodies 20′, assigned to the central magnetic field conductors 18′, of the supporting structure 19, so that an air stream 13 of air can flow through and/or past these support bodies 20′and carry away heat loss. Further downstream, the air ducts 26 each open into one of the said heat exchanger ducts 34, wherein an air stream 13 of air from the air ducts 26 can flow into the heat exchanger ducts 34 and dissipate heat loss, for example, by means of the heat exchanger fins 38 of the heat exchanger ducts 34, along a heat flow 48″ drawn in FIG. 3, into the base plate 6 and to the environment 15. The heat exchanger ducts 34, for their part, open into the interior 10 or into a plurality of so-called air gaps 27 of the stationary induction charging device 4, which are each designed to guide air and are defined in the interior 10 between components of the stationary induction charging device 4, in particular between components of the inductive charging device 9 and the base plate 6. The air gaps 27 connect the heat exchanger ducts 34 fluidically with the fans 31 so that an air stream 13 of air can flow from the heat exchanger ducts 34 through the interior 10 back to the fans 31. According to the embodiment illustrated in FIG. 3, the air gaps 27 are confined, for example, between the air ducts 26 and the magnetic field conductors 18′, 18″, while the air ducts 26 are supported on the base plate 6 or formed therewith.

In other words, the circulation path 14 for an air stream 13 of air extends from the fans 31 through the air distributors 46, the air ducts 26, through and/or past the said support bodies 20′, and/or past the said support bodies 20′, into the heat exchanger ducts 34, through the air gaps 27 and back again to the fans 31. The air stream 13 therefore passes through the fans 31, the air ducts 26, the said support bodies 20′, the heat exchanger ducts 34 and the air gaps 27.

This means that heat loss occurring during operation of the stationary induction charging device 4, in particular at the magnetic field conductors 18′, 18″ of the arrangement 17, preferably at the central magnetic field conductors 18′ and the said support bodies 20′, can be transported from the center of the stationary induction charging device 4 in the area of the central surface 32 to an edge area of the stationary induction charging device 4 at the edge surface 35. This allows all magnetic field conductors 18′, 18″ of arrangement 17 and preferably the central magnetic field conductors 18′ to be cooled relatively homogeneously and better.

FIG. 2 shows a further preferred embodiment of a stationary induction charging device 4 according to the example in a plan view, with the cover 7 of the same almost completely removed in favor of a better recognizability of the air circulation device 12. The embodiment of the stationary induction charging device 4 illustrated in FIG. 2 differs from the embodiment illustrated in FIG. 1 in that only a single fan 31 is provided for conveying air. This indicates a relatively inexpensive, lightweight and energy-efficient embodiment for a stationary induction charging device 4 according to the example.

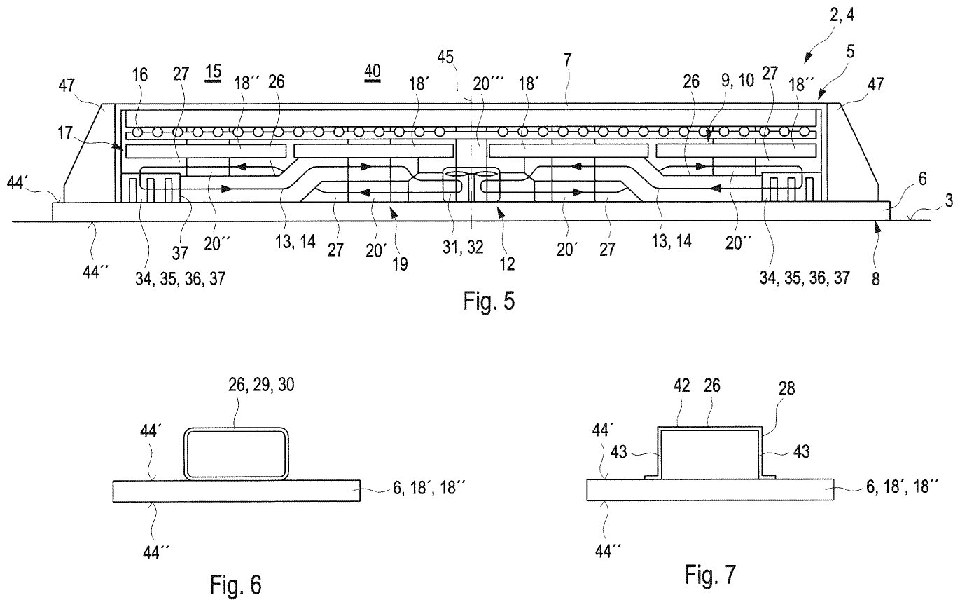

FIGS. 3 through 5 each show a further preferred embodiment of a stationary induction charging device 4 according to the example in a sectional view. The stationary induction charging devices 4 may each be equipped with a single fan 31 for conveying air, as in the embodiment according to FIG. 2, or may have two fans 31 for conveying air, as in the embodiment illustrated in FIG. 1. In the embodiment shown in FIG. 3, it is provided that said air gaps 27 between the air ducts 26 and the magnetic field conductors 18′, 18″ of the arrangement 17 are limited so that the air stream 13 can flow along them. The air ducts 26 are supported on the base plate 6 or formed with it. In the embodiment shown in FIG. 4, the air gaps 27 between the air ducts 26 and the base plate 6 are limited so that the air stream 13 can flow along them. The air ducts 26 are supported on the magnetic field conductors 18′, 18″ of the arrangement 17 or formed with the same. In the embodiment shown in FIG. 5, it is envisaged that the air gaps 27 are bounded, at least in sections, between the air ducts 26 and the magnetic field conductors 18′, 18″ of the arrangement 17 and at least in sections between the air ducts 26 and the base plate 6, so that the air stream 13 can flow along accordingly. The air ducts 26 are supported, at least in sections, on the base plate 6 and, at least in sections, on the magnetic field conductors 18′, 18″ of the arrangement 17, or are formed with the same.

FIGS. 6 and 7 show preferred embodiments of an exemplary air duct 26 of these air ducts 26 in a sectional view. FIG. 6 shows a preferred embodiment of an exemplary air duct 26, one of these air ducts 26, which is made from a simple tubular body 29 or an elastic hose body 30. Such tubular or hose bodies 29, 30 can be flexibly mounted in the interior 10 of the stationary induction charging device 4 and are comparatively inexpensive and available in large quantities on the market. As an alternative to this, FIG. 7 shows an embodiment in which the air duct 26 is formed from the base plate 6 or the magnetic field conductors 18′, 18″ of the arrangement 17 and a U-shaped strip body 28, which has a bottom 42 and side walls 43 connected to one another above the latter and is arranged on the base plate 6 or the magnetic field conductors 18′, 18″ by means of its side walls 43, forming an almost completely fluid-tight or fluid-tight air duct 26.

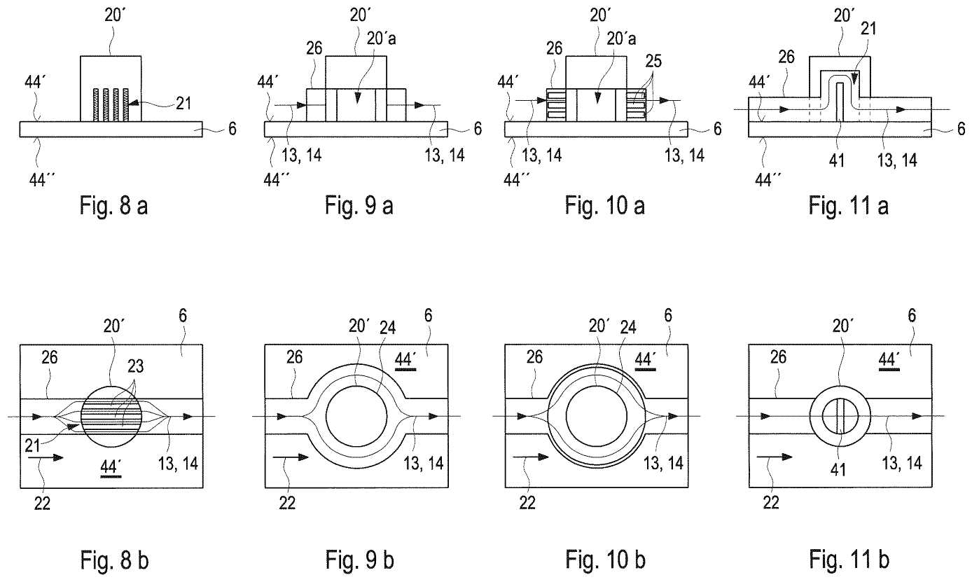

FIGS. 8a) through 11b) show preferred embodiments of a support body 20′ of the first group of support bodies 20′ of the said support bodies 20′, 20″ of the supporting structure 19, which is assigned to a central magnetic field conductor 18′ of the arrangement 17, in a sectional view and a plan view. According to the preferred embodiment shown in FIGS. 8a and 8b, the support body 20′ has a through-opening 21 that passes completely through it, as well as heat exchanger fins 23 that are inserted completely into the same, arranged on the support body 20′ and oriented parallel to a flow direction 22 of the air stream 13. The circulation path 14 extends past the heat exchanger fins 23 through the through-opening 21, so that the air stream 13 passes through the at least one support body 20′ and flows around the heat exchanger fins 23. According to the preferred embodiment shown in FIGS. 9a and 9b, the support body 20′ has a peripheral wall 24 around which the flow circulates, with the circulation path 14 being guided completely around the peripheral wall 24 in two partial paths. This allows the air stream 13 to flow around the support body 20′ in the area of the peripheral wall 24. The support body 20′ also has an exemplary through-opening 20′ a that passes completely through the support body 20′. This can be designed without fins and/or aligned transversely with respect to the air stream 13. According to the preferred embodiment shown in FIGS. 10a and 10b, the support body 20′ has a peripheral wall 24 around which a flow of air 13 can pass, with a plurality of horizontal heat exchanger fins 25 oriented parallel to the direction of flow 22 of the air stream 13. The circulation path 14 is routed around the peripheral wall 24 and the horizontal heat exchanger fins 25 in several partial paths, so that the air stream 13 flows around the peripheral wall 24 and the horizontal heat exchanger fins 25. This support body 20′ also has an exemplary through-opening 20′a that passes completely through the support body 20′. This can be designed without fins and/or aligned transversely with respect to the air stream 13. According to the preferred embodiment shown in FIGS. 11 a and 11 b, the support body 20′ has a through-opening 21 that passes completely through it and a single heat exchanger fin 41 that is inserted into the through-opening and arranged on the support body 20′. The heat exchanger fin 41 is oriented transversely, in particular at right angles, with respect to a direction of flow 22 of the air stream 13, so that it forms a flow obstacle for the air stream 13. The circulation path 14 extends past the heat exchanger fin 41 through the through-opening 21, so that the air stream 13 flushes the support body 20′ and the heat exchanger fin 41.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, ”in examples,“ ”with examples,“ ”various embodiments,“ ”with embodiments,“ ”in embodiments,“ or ”an embodiment,“ or the like, means that a particular feature, structure, or characteristic described in connection with the example/embodiment is included in at least one embodiment. Thus, appearances of the phrases ”examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the sin-gular forms “a”, “an” and “the” are intended to include the plural forms as well, unless the context clearly indicates otherwise. It will also be understood that the phrase at least one of successive elements separated by the word “and” (e.g., “at least one of A and B”) is to be interpreted the same as the term “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. All matter contained in the above description or shown in the accompanying drawings shall be interpreted as illustrative only and not limiting. Changes in detail or structure may be made without departing from the present disclosure.

1. A stationary induction charging device that can be arranged in a fixed position on a flat surface for an inductive vehicle charging system configured to charge a battery of a battery electric vehicle, comprising:
a housing including a base plate and a cover disposed on the base plate, the base plate arranged to dissipate heat to an environment surrounding of the stationary induction charging device;
an inductive charging device arranged in an interior space of the housing, the interior space defined by the base plate and the cover, the inductive charging device in thermal contact with the base plate and configured for electromagnetic interaction with an induction charging device associated with the battery electric vehicle such that electrical energy is inductively transferable between the stationary induction charging device and the battery electric vehicle; and
an air circulation device disposed centrally within the interior space and configured to control a temperature of the stationary induction charging device by directing an air stream along a circulation path extending through the interior space and at least partially along the base plate such that the air stream washes at least a portion of the base plate.

2. The stationary induction charging device according to claim 1, wherein:
the inductive charging device includes an energy coil configured to generate an electromagnetic field for the electromagnetic interaction with the induction charging device associated with the battery electric vehicle and an arrangement of magnetic field conductors associated with the energy coil for guiding the electromagnetic field provided by the energy coil; and
the circulation path extends at least partially along the magnetic field conductors such that the air stream flows around or over at least a portion of the magnetic field conductors.

3. The stationary induction charging device according to claim 1, further comprising a supporting structure disposed within the interior space and configured to:
support an arrangement of magnetic field conductors for guiding an electromagnetic field provided by an energy coil of the inductive charging device at the base plate;
support the cover on the base plate; and
dissipate heat from the magnetic field conductors to the base plate;
wherein the circulation path extends at least partially along the supporting structure such that the air stream flows around or through at least a portion of the supporting structure.

4. The stationary induction charging device according to claim 3, wherein:
the supporting structure includes columnar support bodies that support the cover and the magnetic field conductors on the base plate; and
the circulation path extends along the columnar support bodies such that the air stream flows through and/or around at least a portion of the support bodies.

5. The stationary induction charging device according to claim 4, wherein:
the columnar support bodies include a first group of support bodies associated with central magnetic field conductors;
the columnar support bodies include a second group of support bodies associated with outer magnetic field conductors framing the central magnetic field conductors; and
the air stream flushes and/or washes around at least a portion of the support bodies associated with the central magnetic field conductors.

6. The stationary induction charging device according to claim 5, wherein:
at least one columnar support body of the columnar support bodies includes a through-opening passing through the at least one columnar support body and heat exchanger fins which are inserted into the through-opening, are arranged on the support body and are oriented parallel with respect to a flow direction of the air stream, the circulation path extending along the heat exchanger fins through the through-opening such that the air stream flushes past the at least one support body and around the heat exchanger fins; and/or
at least one columnar support body of the columnar support bodies includes a peripheral wall, the circulation path being guided completely around the peripheral wall in two partial paths such that the air stream washes around the peripheral wall; and/or
at least one columnar support body of the columnar support bodies includes a peripheral wall with horizontal heat exchanger fins oriented parallel with respect to a flow direction of the air stream, the circulation path being guided in two partial paths around the peripheral wall such that the air stream washes around the peripheral wall and the horizontal heat exchanger fins; and/or
at least one support body of the columnar support bodies includes a through-opening passing through the at least one columnar support body and a heat exchanger rib which is inserted into the through-opening, is arranged on the at least one columnar support body and is oriented transversely with respect to a flow direction of the air stream, the circulation path extending along the heat exchanger fin through the through-opening such that the air stream flushes past the at least one support body and around the heat exchanger fin.

7. The stationary induction charging device according to claim 1, wherein the base plate includes at least a portion of a collar extending above the cover and configured to dissipate the heat to the environment surrounding the stationary induction charging device.

8. The stationary induction charging device according to claim 7, further comprising heat-transferring cooling fins arranged on a base surface of the collar facing away from the flat surface, the heat-transferring cooling fins configured to release the heat into the environment.

9. The stationary induction charging device according to claim 1, wherein:
the air circulation device includes at least one air duct for guiding air;
at least one air gap is defined in the interior space for air guidance; and
the circulation path extends through the at least one air duct and the at least one air gap such that the air stream flushes the at least one air duct and the at least one air gap.

10. The stationary induction charging device according to claim 9, wherein:
the at least one air duct includes at least a portion of the base plate or at least portion of magnetic field conductors, and a U-shaped strip body including a base and side walls, the U-shaped strip body arranged on the base plate or the magnetic field conductors; or
at least one air duct includes a tubular body; or
at least one air duct includes an elastic hose body.

11. The stationary induction charging device according to claim 10, wherein:
the at least one air gap is delimited between the at least one air duct and the magnetic field conductors and the at least one air duct is supported on or formed by the base plate; or
the at least one air gap is delimited between the at least one air duct and the base plate, and the at least one air duct is supported on or formed by the magnetic field conductors; or
the at least one air gap is delimited at least partially between the at least one air duct and the magnetic field conductors, and the least one air gap is delimited at least partially between the at least one air duct and the base plate, and the at least one air duct is supported or formed at least partially on the base plate and at least partially on the magnetic field conductors.

12. The stationary induction charging device according to claim 1, wherein:
the air circulation device has at least one fan for directing air along the circulation path, and/or
at least one fan on a central surface of the base plate within the interior space.

13. The stationary induction charging device according to claim 1, wherein:
the air circulation device includes at least one heat exchanger duct arranged on an edge surface of the base plate bordering a central surface of the base plate for transferring heat from the air stream to the base plate; and
the circulation path extends through the at least one heat exchanger duct such that the air stream flushes the at least one heat exchanger duct.

14. The stationary induction charging device according to claim 13, wherein:
the at least one heat exchanger duct comprises one or more of:
a placement in a corner area of the edge surface;
a tubular body;
heat exchanger fins for transferring heat from the air stream to the base plate and/or for guiding the air stream;
air guide elements for guiding the air stream and/or for transferring heat from the air stream to the base plate;
a T-shaped configuration dividing the circulation path into two partial paths; and/or
at least one opening at an end of each flow path of the circulation path through the heat exchanger duct such that the air guided in the air stream can flow out of the heat exchanger duct and into at least one air gap within the interior space.

15. An inductive vehicle charging system configured to charge a battery of a battery electric vehicle with electrical energy, comprising:
a stationary induction charging device comprising:
a housing including a base plate and a cover disposed on the base plate, the base plate arranged to dissipate heat to an environment surrounding the stationary induction charging device;
an inductive charging device arranged in an interior space of the housing, the interior space defined by the base plate and the cover, the inductive charging device in thermal contact with the base plate and configured for electromagnetic interaction with an induction charging device associated with the battery electric vehicle such that electrical energy is inductively transferable between the stationary induction charging device and the battery electric vehicle; and
an air circulation device disposed centrally within the interior space and configured to control a temperature of the stationary induction charging device by directing an air stream along a circulation path extending through the interior space and at least partially along the base plate such that the air stream washes at least a portion of the base plate.

16. The inductive vehicle charging system according to claim 15, wherein:
the inductive charging device includes an energy coil configured to generate an electromagnetic field for electromagnetic interaction with the induction charging device associated with the battery electric vehicle and arrangement of magnetic field conductors associated with the energy coil for guiding the electromagnetic field provided by the energy coil; and
the circulation path extends at least partially along the magnetic field conductors such that the air stream flows around or over at least a portion of the magnetic field conductors.

17. The inductive vehicle charging system according to claim 15, further comprising a supporting structure disposed within the interior space and configured to:
support an arrangement of magnetic field conductors for guiding an electromagnetic field provided by an energy coil of the inductive charging device at the base plate;
support the cover on the base plate; and
dissipate heat from the magnetic field conductors to the base plate;
wherein the circulation path extends at least partially along the supporting structure such that the air stream flows around or through at least a portion of the supporting structure.

18. The inductive vehicle charging system according to claim 17, wherein:
the supporting structure includes columnar support bodies that support the cover and the magnetic field conductors on the base plate; and
the circulation path extends along the columnar support bodies such that the air stream flows through and/or around at least a portion of the support bodies.

19. The inductive vehicle charging system according to claim 18, wherein:
the columnar support bodies include a first group of support bodies associated with central magnetic field conductors;
the columnar support bodies include a second group of support bodies associated with outer magnetic field conductors framing the central magnetic field conductors; and
the air stream flushes and/or washes around at least a portion of the support bodies associated with the central magnetic field conductors.

20. The inductive vehicle charging system according to claim 15, wherein:
the air circulation device has at least one fan for directing air along the circulation path, and/or
at least one fan on a central surface of the base plate within the interior space.
